(19) United States
(12) Patent Application Publication
(10) Pub. No.: US 2026/0214099 A1
(43) Pub. Date: Jul. 23, 2026

(54) METHODS, DEVICES, PROCESSORS AND SYSTEMS FOR MANAGING ACCESS TO DESTINATIONS IN A SYSTEM

(71) Applicant: Y.E. Hub Armenia LLC, Yerevan (AM)

(72) Inventor: Boris LYTOCHKIN, Moscow (RU)

(21) Appl. No.: 19/442,036

(22) Filed: Jan. 7, 2026

(30) Foreign Application Priority Data
Jan. 20, 2025 (RU) 2025101008

(51) Int. Cl. H04L 9/40

(52) U.S. Cl. CPC H04L 63/104; H04L 63/02

(57) ABSTRACT

Methods, servers, and processors for managing access to destinations in a system are disclosed. The method includes acquiring a plurality of access rules, generating a group score for the user group based on a number of users in the user group and a number of destinations for the user group amongst the plurality of access rules, in response to the group score being above a pre-determined threshold generating a modified access rule indicative of a meta-user and the destination, generating a meta-user index record for the meta-user, and generating user index records for respective ones from the users in the user group.

### CROSS-REFERENCE

The present application claims priority to Russian Patent Application No. 2025101008, entitled “Methods, Devices, Processors and Systems for Managing Access to Destinations in a System”, filed Jan. 20, 2025, the entirety of which is incorporated herein by reference.

### FIELD

The present technology relates to access management systems in general, and more specifically, to methods, devices, processors and systems for managing access to destinations in a system.

### BACKGROUND

Organizations, particularly those with complex structures such as multiple departments, sub-groups, and hierarchical arrangements, often rely on centralized systems to manage access to their digital resources. These systems are used for ensuring that users within the organization, such as employees, contractors, and administrators, are provided appropriate access privileges while maintaining the integrity and security of the underlying infrastructure. To facilitate such access control, firewall servers play a role in managing and enforcing rules that govern how users interact with various resources hosted by the organization.

A firewall server is an intermediary mechanism between users and the protected resources. It monitors and regulates incoming and outgoing traffic based on predefined access rules, thereby restricting unauthorized or unintended access to sensitive systems. Such systems are typically designed to handle access requests in environments characterized by organizational groupings. These environments may include multiple departments, each containing several sub-groups or teams, where each group or sub-group may have distinct roles, responsibilities, and levels of access requirements. For example, employees within one department may require access to a specific subset of resources, whereas individuals in a different department, or even within the same department but in a different sub-group, may require access to a different combination of resources.

To address the access requirements of such organizational structures, management access systems are employed to generate, define, and store access rules. These access rules are typically configurable, allowing them to be tailored to the specific needs of users, groups, and sub-groups within the organization. Such systems ensure that access privileges are granted in accordance with users' roles and responsibilities, thereby reducing the risk of unauthorized access while maintaining operational efficiency. The generated access rules serve as directives for the firewall server, enabling it to enforce user-specific access privileges based on the resources available in the system.

In addition to defining access rules, management access systems are often designed to adapt to evolving organizational requirements. For instance, users may transition between departments or sub-groups, or their roles may change over time, necessitating adjustments to their access privileges. To accommodate such changes, access management systems may include functionalities for dynamically updating and modifying the stored rules to reflect the current state of access requirements. The stored rules are indicative of the resources users are permitted to access, such as specific servers, databases, or applications, and these permissions can be monitored and enforced in real-time by the firewall server. By integrating access rules that can be tailored for specific users, groups, and sub-groups, such systems enable a precise and controlled approach to resource management. This not only enhances the security of the organization's systems but also supports the scalability of access management in environments with expanding or shifting organizational structures.

US Patent publication 2014/0245423 disclose a peripheral firewall system for application protection in cloud computing environments.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

As organizations expand, the number of users, groups, and corresponding access rules can increase exponentially, presenting significant scalability challenges for both management access systems and firewall servers. In large-scale environments, where thousands of users interact with complex hierarchies of resources, the sheer volume of access rules can strain system performance and storage capabilities. Each user may require multiple access rules, which collectively contribute to a massive rule set that must be stored, processed, and enforced in real-time by the firewall server.

At least one scalability issue arises from the computational burden associated with rule evaluation. Firewall servers may need to continuously compare incoming access requests against the stored rule set to determine whether a particular user can access a specific resource/destination. As the number of rules grows, the time required to process and match rules increases proportionally. This can lead to latency in access decisions, particularly when the rules involve intricate conditions or dependencies, such as time-based restrictions, role hierarchies, or group-based permissions. Developers of the present technology have realized that such delays can impair operational efficiency and disrupt user workflows.

At least one other challenge relates to the storage and organization of access rules. Large organizations may need to store millions of rules, each corresponding to different users, departments, and resource/destination permissions. Traditional storage systems may become inefficient in managing these massive datasets, particularly when access rules are frequently updated or modified to reflect organizational changes. Fragmented and/or redundant rule storage further exacerbates scalability issues, as it leads to increased memory usage and slower retrieval times during access enforcement.

Furthermore, the complexity of managing overlapping or conflicting rules can impact system scalability. In organizations with extensive hierarchies, it is not uncommon for multiple rules to apply to a single user or resource/destination, resulting in conflicts that must be resolved during rule evaluation. Ensuring that the most specific and appropriate rule is applied requires additional computational logic, further taxing the firewall server's processing capabilities. In environments with tens of thousands of users and dynamic role transitions, this complexity can grow unmanageable without advanced rule optimization techniques.

In at least some embodiments of the present technology, there is provided access management systems employing optimization strategies such as (i) rule aggregation, (ii) hierarchical rule processing, and/or (iii) indexing mechanisms. For exmaple, the access management system may be configured to modify and/or consolidate access rules to reduce redundancy for minimizing the size of the rule set while maintaining granularity and flexibility in access control.

In at least some embodiments of the present technology, there is provided access management systems leveraging distributed architectures and parallel processing to enhance the scalability of rule evaluation, allowing firewall servers to process large volumes of rules efficiently. Caching frequently accessed rules and prioritization schemes during rule evaluations can also be employed to reduce latency and improve system performance.

In at least some embodiments of the present technology, an access management system may be configured to acquire a plurality of access rules indicative of user groups and destinations for providing users in the user groups with access to the destinations in accordance with the access rules. It is contemplated that generating group scores can be generated for respective user groups based on respective members in the user groups and number of destinations for the respective user groups amongst the plurality of access rules.

Developers of the present technology have realized that group scores may be leveraged for optimizing storage of access rules in a storage system. In at least some embodiments, the group scores can be employed for generating modified access rules for optimizing how index records in a storage are generated for providing appropriate access control based on the plurality of original access rules. As it will become apparent herein further below, the modified rules can be leveraged for generating a “meta-user” index record for “meta-user” entities, and user index records for respective users with respective references to the meta-user index records. This combination of meta-user and real-user index records may allow optimization of storage requirements for enabling appropriate access control to a given system.

In a first broad aspect of the present technology, there is provided a method for managing access to destinations in a system, the method executable by a processor, the method comprising: acquiring a plurality of access rules, a given access rule from the plurality of access rules being indicative of a user group and a destination, the given access rule for providing users in the user group with access to the destination; generating a group score for the user group based on a number of users in the user group and a number of destinations for the user group amongst the plurality of access rules; in response to the group score being above a pre-determined threshold: generating a modified access rule indicative of a meta-user and the destination, the modified access rule to be used instead of the given access rule for providing the users in the user group with access to the destination; generating a meta-user index record for the meta-user, the meta-user index record including information indicative of the destination; and generating user index records for respective ones from the users in the user group, a given user index record including information indicative of the meta-user index record.

In some embodiments of the method, a given user index record includes information indicative of a plurality of meta-user index records, the plurality of meta-user index records including the meta-user index record, the method further comprising: in response to a number of meta-user index records in the plurality of meta-user index records being above an other pre-determined threshold: updating the given user index record by replacing information indicative of the meta-user index record by information indicative of the destination.

In some embodiments of the method, the method further comprises: determining that a given modified access rule comprises references to a number of users that is above an other pre-determined threshold; determining references to a set of users in the modified ruleset to be replaced by a reference to a first meta-user; generating an optimized modified access rule to be used instead of the given modified access rule, the optimized modified access rule comprising the reference to the first meta-user instead of the references to a set of users in the given modified access rule.

In some embodiments of the method, the destination is at least one of an IP address, a hostname, a subnetwork, a port, and a protocol within a resource of the system.

In some embodiments of the method, the processor is a processor of a firewall server of the system.

In some embodiments of the method, the method further comprises: generating an index structure in a database system, the index structure including the meta-user index record and the user index record.

In some embodiments of the method, the group score is a product of destination count and a member count for the given group.

In a second broad aspect of the present technology, there is provided a firewall server configured to: acquire a plurality of access rules, a given access rule from the plurality of access rules being indicative of a user group and a destination, the given access rule for providing users in the user group with access to the destination; generate a group score for the user group based on a number of users in the user group and a number of destinations for the user group amongst the plurality of access rules; in response to the group score being above a pre-determined threshold: generate a modified access rule indicative of a meta-user and the destination, the modified access rule to be used instead of the given access rule for providing the users in the user group with access to the destination; generate a meta-user index record for the meta-user, the meta-user index record including information indicative of the destination; and generate user index records for respective ones from the users in the user group, a given user index record including information indicative of the meta-user index record.

In some embodiments of the firewall server, a given user index record includes information indicative of a plurality of meta-user index records, the plurality of meta-user index records including the meta-user index record, the method firewall server being further configured to: in response to a number of meta-user index records in the plurality of meta-user index records being above an other pre-determined threshold: updating the given user index record by replacing information indicative of the meta-user index record by information indicative of the destination.

In some embodiments of the firewall server, the firewall server is further configured to: determine that a given modified access rule comprises references to a number of users that is above an other pre-determined threshold; determine references to a set of users in the modified ruleset to be replaced by a reference to a first meta-user; generate an optimized modified access rule to be used instead of the given modified access rule, the optimized modified access rule comprising the reference to the first meta-user instead of the references to a set of users in the given modified access rule.

In some embodiments of the firewall server, the destination is at least one of an IP address, a hostname, a subnetwork, a port, and a protocol within a resource of the system.

In some embodiments of the firewall server, the firewall server is further configured to: generate an index structure in a database system, the index structure including the meta-user index record and the user index record.

In some embodiments of the firewall server, the group score is a product of destination count and a member count for the given group.

In a third broad aspect of the present technology, there is provided a processor configured to: acquire a plurality of access rules, a given access rule from the plurality of access rules being indicative of a user group and a destination, the given access rule for providing users in the user group with access to the destination; generate a group score for the user group based on a number of users in the user group and a number of destinations for the user group amongst the plurality of access rules; in response to the group score being above a pre-determined threshold: generate a modified access rule indicative of a meta-user and the destination, the modified access rule to be used instead of the given access rule for providing the users in the user group with access to the destination; generate a meta-user index record for the meta-user, the meta-user index record including information indicative of the destination; and generate user index records for respective ones from the users in the user group, a given user index record including information indicative of the meta-user index record.

In some embodiments of the processor, a given user index record includes information indicative of a plurality of meta-user index records, the plurality of meta-user index records including the meta-user index record, the processor being further configured to: in response to a number of meta-user index records in the plurality of meta-user index records being above an other pre-determined threshold: update the given user index record by replacing information indicative of the meta-user index record by information indicative of the destination.

In some embodiments of the processor, the processor is further configured to: determine that a given modified access rule comprises references to a number of users that is above an other pre-determined threshold; determine references to a set of users in the modified ruleset to be replaced by a reference to a first meta-user; generate an optimized modified access rule to be used instead of the given modified access rule, the optimized modified access rule comprising the reference to the first meta-user instead of the references to a set of users in the given modified access rule.

In some embodiments of the processor, the destination is at least one of an IP address, a hostname, a subnetwork, a port, and a protocol within a resource of the system.

In some embodiments of the processor, the processor is further configured to: generate an index structure in a database system, the index structure including the meta-user index record and the user index record.

In some embodiments of the processor, the group score is a product of destination count and a member count for the given group.

In some embodiments of the processor, the processor is a processor of a firewall server communicatively coupled to a database system.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a computer system, in accordance with at least some non-limiting embodiments of the present technology.

FIG. 2 is a schematic representation of a networked system, in accordance with at least some non-limiting embodiments of the present technology.

FIG. 3 is an illustration of a non-limiting example of an organization structure, in accordance with at least some non-limiting embodiments of the present technology.

FIG. 4 is an illustration of representations of a processing pipeline executable by the computer system of FIG. 1, in accordance with at least some non-limiting embodiments of the present technology.

FIG. 5 is a scheme-block representation of a method executable by the computer system of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

With these fundamentals in place, we will now consider some non-limiting examples to illustrate various implementations of aspects of the present technology.

### Computer System

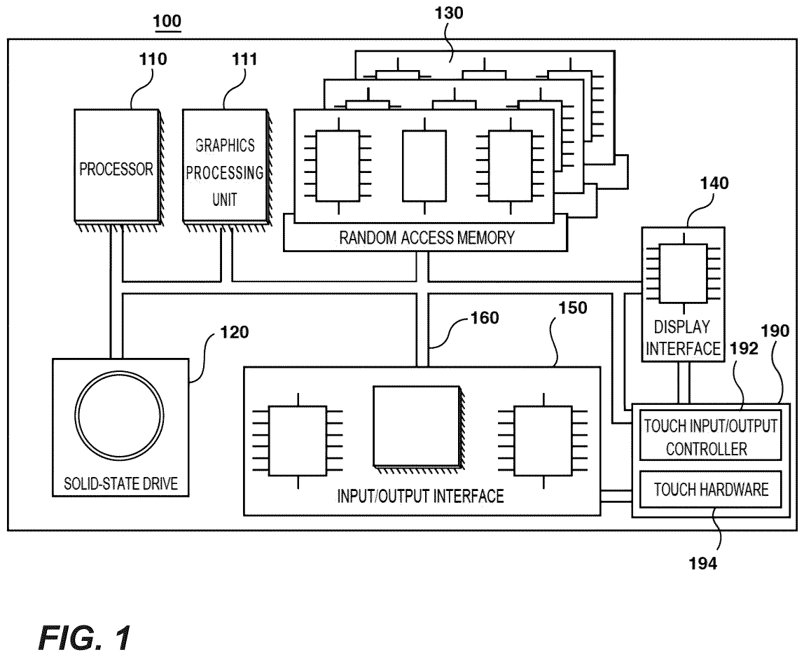

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library and/or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted that some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160. In some embodiments, the touch hardware 194 may comprise pressure-sensitive cells embedded in a layer of a display allowing detection of a physical interaction between a user and the display.

It should be noted that various implementations of the computer system 100 are contemplated. As it will become apparent from the description herein further below, one or more computer system connected over communication network may be implemented similarly to the computer system 100, without departing from the scope of the present technology.

### Networked Environment

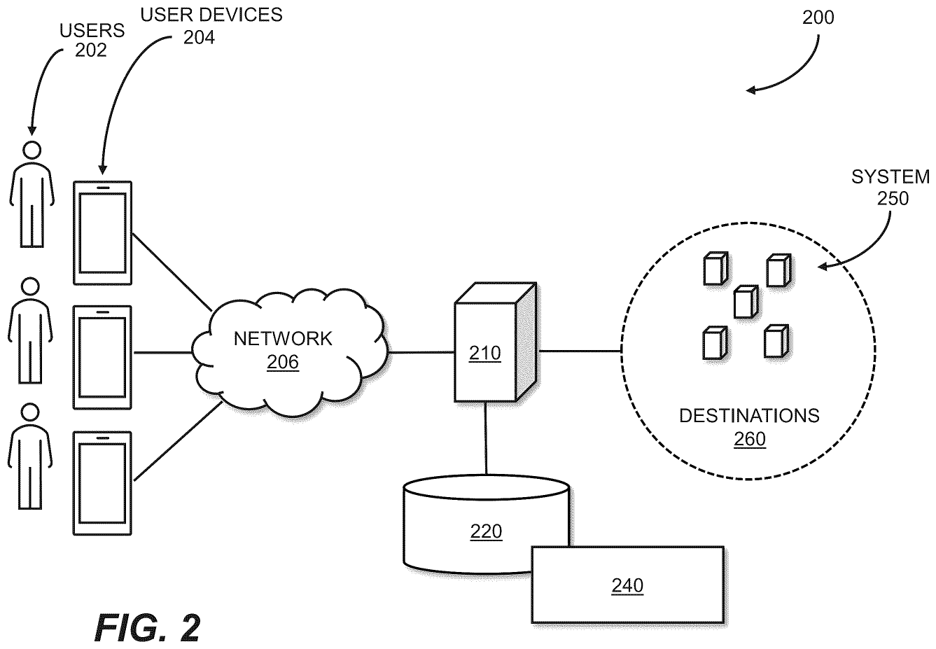

Referring to FIG. 2, there is shown a schematic diagram of a networked environment 200, the networked environment 200 being suitable for implementing non-limiting embodiments of the present technology. It is to be expressly understood that the networked environment 200 as depicted is merely an illustrative implementation of the present technology. Thus, the description thereof that follows is intended to be only a description of illustrative examples of the present technology.

Broadly speaking, the networked environment 200 is configured for providing access to resources in a system 250. To that end, the networked environment 200 comprises inter alia a plurality of electronic devices 204 associated with users 202, a firewall server 210, a database system 220, and the system 250 with a plurality of resources/destinations 260.

For example, a given user 202 via the electronic device 204 may desire to access the system 250. The firewall server 210 may be configured to access the database system 220 to determine which resources/destinations the user 202 is allowed to access in the system 250, and if the current resource/destination is allowed by the access rules in the database system 220, the firewall server 210 may allow the user 202 to access the current resources/destinations in the system 250. Some functionality of components of the networked environment 200 will now be described in greater detail.

As mentioned above, the networked environment 200 comprises a plurality of electronic devices comprising the electronic device 204 associated with the user 202. As such, the electronic device 204, or simply “device” 204 can sometimes be referred to as a “client device”, “end user device” or “client electronic device”. It should be noted that the fact that the electronic device 204 is associated with the user 202 does not need to suggest or imply any mode of operation—such as a need to log in, a need to be registered, or the like.

In the context of the present specification, unless provided expressly otherwise, “electronic device” or “device” is any computer hardware that is capable of running a software appropriate to the relevant task at hand. Thus, some non-limiting examples of the device 204 include personal computers (desktops, laptops, netbooks, etc.), smartphones, tablets and the like. The device 204 comprises hardware and/or software and/or firmware (or a combination thereof), as is known in the art, to execute an application for accessing the system 250.

Returning to the description of FIG. 2, the networked environment 200 comprises the communication network 206. In one non-limiting example, the communication network 206 may be implemented as the Internet. In other non-limiting examples, the communication network 206 may be implemented differently, such as any wide-area communication network, local-area communication network, a private communication network and the like. In fact, how the communication network 206 is implemented is not limiting and will depend on inter alia how other components of the networked environment 200 are implemented.

The purpose of the communication network 206 is to communicatively couple at least some of the components of the networked environment 200 such as the device 204, the firewall server 210, and the system 250. For example, this means that the firewall server 210 and/or the system 250 is accessible via the communication network 206 by the device 204.

The communication network 206 may be used in order to transmit data packets amongst the device 204, the firewall server 210, and the system 250. For example, the communication network 206 may be used to transmit data requests from the device 204 to the firewall server 210. In another example, the communication network 206 may be used to transmit the data responses from the firewall server 210 to the device 204.

The networked environment 200 comprises the firewall server 210 that may be implemented as a conventional computer server. In an example of an embodiment of the present technology, the firewall server 210 may be implemented as a Dell™ PowerEdge™ Server running the Microsoft™ Windows Server™ operating system. Needless to say, the firewall server 210 may be implemented in any other suitable hardware and/or software and/or firmware or a combination thereof. In the depicted non-limiting embodiment of present technology, the firewall server 210 is a single server. In alternative non-limiting embodiments of the present technology, the functionality of the firewall server 210 may be distributed and may be implemented via multiple servers.

Generally speaking, the firewall server 210 is under control and/or management of an organization such as, for example, an operator of the system 250. The firewall server 210 performs several functions to secure and manage access to organizational resources in the system 250. It can continuously monitor and filter incoming and outgoing network traffic, analyzing data packets against predefined access rules to allow or block requests. By enforcing access control, the firewall server 210 ensures that only authorized users can interact with specific resources/destinations in the system 250. It also processes, stores, and dynamically applies access rules, tailoring privileges to users, groups, and sub-groups in an organization. Acting in a sense as a “protective barrier”, the firewall server 210 prevents unauthorized access, data breaches, and malicious activities, ensuring the integrity and confidentiality of resources/destinations in the system 250. Additionally or optionally, the firewall server 210 can be designed to scale and adapt to evolving organizational requirements, accommodating changes in access rules, user roles, and resource availability while maintaining security and performance.

For example, the firewall server 210 may receive the data requests from the device 204 indicative of a desired access by the user 202 to a given resource/destination in the system 250. The firewall server 210 may be configured to access data stored in the database system 250 for verifying whether or not to grant access to the user to the given resource/destination in the system 250. As a result, the firewall server 210 may be configured to allow or prohibit access to the given resource/destination in the system 250 based on data retrieved from the database system 220.

The database system 220 may comprise a database that stores an index structure 240. Broadly speaking, the index structure 240 stored in the database system 220 is used to manage entries for users and their corresponding destinations which they are allowed to access. The index structure 240 serves as an efficient mechanism to organize and retrieve access information for decision-making by the firewall server 210.

It can be said that the index structure 240 maps individual users to the destinations, such as servers, databases, or applications, to which they have access. By structuring this data in an optimized format, the index structure 240 facilitates rapid lookups and ensures that access requests can be efficiently processed. When a user attempts to access a resource, the firewall server 210 can query the index structure 240 to determine whether the requested destination aligns with the user's permissions. This may reduce the computational overhead associated with scanning large datasets, especially in organizations with thousands of users and resources. Furthermore, the index structure 240 supports dynamic updates, allowing entries to be modified, added, or removed as users' roles or access requirements change over time. By enabling quick retrieval and efficient management of access mappings, the index structure 240 enhances the performance of the firewall server 210. As it will be described in greater details herein further below, the index structure 240 may comprise at least two types of entries including “meta-user” index records for “meta-user” entities, and “user” index records for respective users with respective references to the meta-user index records. This combination of meta-user and real-user index records may allow optimization of storage requirements for enabling appropriate access control to the system 250.

It should be noted that during generating of the index structure 240, the firewall server 210 may be configured to acquire a plurality of access rules indicative of users and/or user groups as well as corresponding destinations to which the users and/or user groups are to be provided with access. The firewall server 210 may then be configured to process to the plurality of access rules and generate a plurality of index records in the index structure 240 for controlling access to the destinations when specific users attempt to access the system 250.

In the context of an access rule, a destination refers to the specific resource, sub-system, or endpoint that a user or user group is attempting to access within the system 250. A destination may include servers, databases, applications, devices, or any other digital resource protected by the firewall server 210. The destination is a component of an access rule, as it defines where the traffic or request is ultimately directed. For example, an access rule might specify that a particular user or user group can access a destination server hosting sensitive financial data, but not a server hosting human resource records. Similarly, the destination could be an IP address, a hostname, a subnet, or even specific ports or protocols within a targeted resource. By defining the destination in access rules, the firewall server 210 may determine that requests are appropriately filtered and directed only to authorized resources/destinations, thereby enforcing controlled access and maintaining system security.

In the context of an access rule, a user group refers to a collection of users who ought to share common access requirements or privileges within a system. Instead of issuing individual access rules to each user, user groups can be used in an access rule to simplify and streamline the management of permissions. For example, employees in the same department, team, or sub-group can be grouped together, and a single access rule can be issued for the firewall server 210. When a user group is referenced in a single access rule, the firewall server 210 is configured to enforce same access privileges for all users within that group.

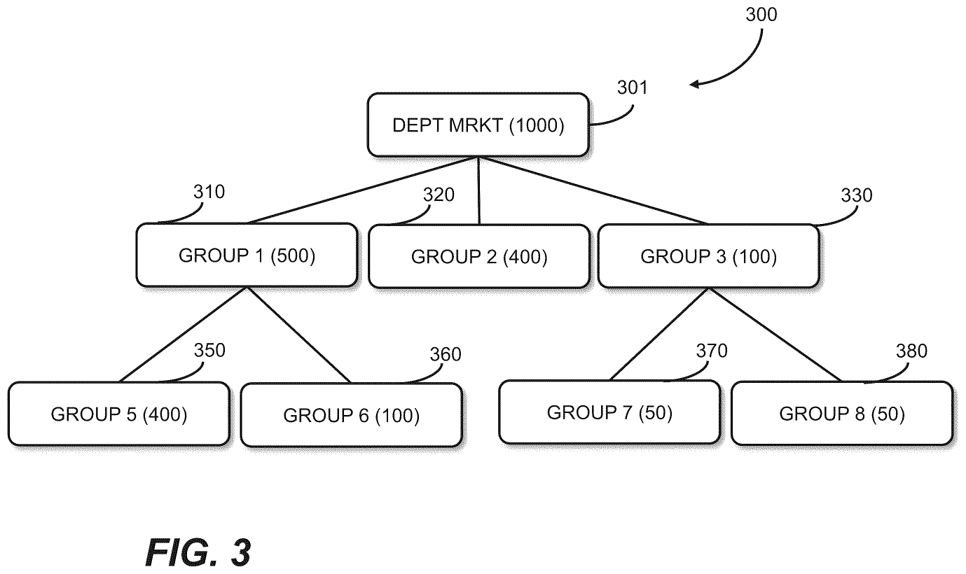

With reference to FIG. 3, there is depicted a non-limiting example of an organization structure 300 as contemplated in some embodiments of the present technology. Non-limiting examples of access rules will be described herein further below with reference to the organization structure 300.

In this non-limiting example, the organization structure 300 is built for a marketing department 301 of an organization operating the system 250. The marketing department 301 includes one thousand individuals. In this non-limiting example, the marketing department 301 comprises a first group 310 comprising five hundred individuals, a second group 320 comprising four hundred individuals, and a third group 330 comprising one hundred individuals. In this non-limiting example, the first group 310 comprises a fifth group 350 (a sub-group of the first group 310) of four hundred individuals and a sixth group 360 (an other sub-group of the first group 310) of one hundred individuals. In this non-limiting example, the third group 330 comprises a seventh group 370 (a sub-group of the third group 330) of fifty individuals and an eighth group 380 (an other sub-group of the third group 330) of fifty individuals.

In one non-limiting example, a plurality of individual users may be defined for the firewall server 210 for managing access to one or more resources in the system 250. For example, a user879 may be defined for the firewall server 210. In this non-limiting example, once the plurality of individual users is defined, one or more groups of users may be defined for the firewall server 210 for managing access to one or more resources in the system 250. For example, a group5 may be defined for the firewall server 210 by identifying a particular group of users from the plurality of individual users.

Once one or more individual users and one or more groups of users are defined, the firewall server 210 may be configured to acquire one or more access rules for configuration of the database system 240. In this non-limiting example, let it be assumed that the firewall server 210 is configured to acquire an original ruleset comprising the following access rules:
first original access rule: allow tcp from @dpt_marketing@ to host.example.com http
second original access rule: allow tcp from {@group5@} to secure.example.com http
third original access rule: allow udp from {% user879%} to corpdns.example.com 53

In this non-limiting example, the firewall server 210 may be configured to perform a preliminary rule modification procedure for generating a preliminary modified ruleset. To that end, the firewall server 210 may be configured to use a pre-determined group split threshold value for modifying granularity of groups expressed in the original ruleset. Let it be assumed that the pre-determined group split threshold value is equal to one hundred individuals. In this non-limiting example, the firewall server 210 is configured to modify/split the large groups referenced in the original ruleset so as to show the smallest referenced groups but are still above the pre-determined group split threshold value (e.g., one hundred individuals). As a result, in this non-limiting example, the firewall server 210 may be configured to generate the preliminary modified rule set comprising the following preliminary modified access rules:
first preliminary modified access rule: allow tcp from {@group5@ or @group6@ or @group2@ or @group3@} to host.example.com http
second original access rule: allow tcp from {@group5@} to secure.example.com http
third original access rule: allow udp from {% user879%} to corpdns.example.com 53

In this non-limiting example, second and third original access rules have not been modified since they referenced the fifth group 350 (with four hundred individuals without smaller sub-groups) and a single user (user879) respectively. In this non-limiting example, first original access rule has been modified because it referenced the marketing department group 301 which includes smaller groups that are above one hundred individuals. In this non-limiting example, the first preliminary modified access rule no longer references the marketing department group 301, and instead references the fifth group 350, the sixth group 360, the second group 320, and the third group 330—that is, the smallest possible groups under the marketing department 301 but which are above one hundred individuals. For example, the third group 330 is referenced because, even if it includes smaller groups (the seventh group 370 and the eighth group 380), the smaller groups under the third group 330 have less individuals than the pre-determined group split threshold value (of one hundred individuals).

Developers of the present technology have realized that storing information indicative of the preliminary modified ruleset in the indexing structure 240 may require one thousand four hundred and one entries. In this non-limiting example, a number of entries to be stored for representing the preliminary modified rule set is as follows:
allow tcp from { . . . } to host.example.com http—the first preliminary modified access rule requires “1000” entries because a reference to the host.example.com http destination needs to be stored for each of the one thousand users in the fifth group 350, the sixth group 360, the second group 320, and the third group 330;
allow tcp from { . . . } to secure.example.com http—the second original access rule requires “400” entries because a reference to the secure.example.com http destination needs to be stored for each one of four hundred users in the fifth group 350;
allow udp from {% user879%} to corpdns.example.com 53—the third original access rule requires “1” entry because a reference to the corpdns.example.com 53 destination needs to be stored for only the user879.

Developers of the present technology have devised solutions for further processing at least one of the original ruleset and the preliminarily modified ruleset for generating a modified ruleset which requires comparatively less storage entries for storing permissions expressed in the original ruleset. How the firewall server 210 may generate the afore-mentioned modified ruleset will now be described in greater details.

In some embodiments of the present technology, the firewall server 210 may be configured to perform a destination count operation for determining a number of destinations referenced across the preliminary modified ruleset for respective user groups referenced across the preliminary modified ruleset. In this non-limiting example, the firewall server 210 may be configured to generate a destination count operation as follows:
@group5@->has a destination counter equal to “2” since two destinations (host.example.com http and secure.example.com http) are referenced for the fifth group 350 across the preliminary modified ruleset;
@group6@->has a destination counter equal to “1” since one destination (host.example.com http) is referenced for the sixth group 360 across the preliminary modified ruleset;
@group2@->has a destination counter equal to “1” since one destination (host.example.com http) is referenced for the second group 320 across the preliminary modified ruleset;
@group3@->has a destination counter equal to “1” since one destination (host.example.com http) is referenced for the third group 330 across the preliminary modified ruleset.

The firewall server 210 may then be configured to perform a group score computation operation for generating a group score for each group referenced in the preliminary modified ruleset. To that end, the firewall server 210 may be configured to apply a metric function on respective groups referenced in the preliminary modified ruleset. In one non-limiting example, it can be said that a given group score (output of the metric function) is a function of a destination counter for the given group and a member counter for the given group (number of users in the given group). Other counters are contemplated in addition to, or instead of, the destination counter and the member counter for computing the given group score, without departing from the scope of the present technology. Once the group scores are generated by the firewall server 210 for respective groups referenced in the preliminary modified ruleset, the firewall server 210 is configured to apply a pre-determined group threshold value for determining which groups are associated with group scores above the pre-determined group threshold value, and which groups are associated with group scores below the pre-determined group threshold value. For example, the firewall server 210 may be configured to perform group score computation operation as follows:
metric(group) =f(dst_count, member_count)—the metric computable by the firewall server 210 is a function of the destination counter of a given group and a member counter for the given group;
f=dst_count*member_count—in at least one embodiment of the present technology, the function may be a product of the destination counter of the given group and the member counter for the given group;
metric_threshold=700—in at least one embodiment of the present technology, the pre-determined group threshold value may be equal to seven hundred;
group score for @group5@->is equal to “800” since the destination counter for the fifth group 350 is “2” and the member counter for the fifth group 350 is “400” and is above the pre-determined group threshold value of “700”;
group score for @group6@->is equal to “100” since the destination counter for the sixth group 350 is “1” and the member counter for the sixth group 350 is “100” and is below the pre-determined group threshold value of “700”;
group score for @group2@->is equal to “400” since the destination counter for the second group 320 is “1” and the member counter for the second group 320 is “400” and is below the pre-determined group threshold value of “700”; and
group score for @group3@->is equal to “100” since the destination counter for the second group 330 is “1” and the member counter for the third group 330 is “100” and is below the pre-determined group threshold value of “700”.

In this non-limiting example, only the group score for the fifth group 350 is above the pre-determined group threshold value. As a result, the fifth group 350 may be considered by the firewall server 210 as a “meta-user” entity when generating a modified ruleset and/or when generating index records in the index structure 240. For example, the firewall server 210 may be configured to generate a modified ruleset comprising the following modified access rules:
allow tcp from {% metauser_group5% or @group6@ or @group2@ or @group3@} to host.example.com http
allow tcp from {% metauser_group5%} to secure.example.com http
allow udp from {% user879% } to corpdns.example.com 53

Developers of the present technology have realized that storing information indicative of the modified ruleset in the indexing structure 240 may require six hundred and three entries, as opposed to one thousand four hundred and one entries. In this non-limiting example, a number of entries to be stored for representing the modified rule set is as follows:
allow tcp from {% metauser_group5% or @group6@ or @group2@ or @group3@} to host.example.com http—requires “601” entries because a reference to the host.example.com http destination needs to be stored for each of the six hundred users in the sixth group 360, the second group 320, and the third group 330, and for one meta-user representing the fifth group 350 as a whole;
allow tcp from {% metauser_group5%} to secure.example.com http—requires “1” entry because a reference to the secure.example.com http destination needs to be stored for one meta-user representing the fifth group 350 as a whole;
allow udp from {% user879%} to corpdns.example.com 53—requires “1” entry because a reference to the corpdns.example.com 53 destination needs to be stored for only the user879.

In some embodiments of the present technology, the firewall server 210 is configured to generate index records in the index structure 240 for both users and meta-users from the modified ruleset. In this non-limiting example, the firewall server 210 may be configured to generate a meta-user index record for the meta-user representing the fifth group 350 as follows:
% metauser_group5%:
firewall entries {
   tcp host.example.com http
   tcp secure.example.com http
}

In this non-limiting example, the meta-user index record includes the two destinations from the modified ruleset for the meta-user representing the fifth group 350. Let it be assumed that a user543 in the organization structure 300 is not in the fifth group 350. For example, the user543 in the organization structure 300 may be in the seventh group 370. In this non-limiting example, the firewall server 210 may be configured to generate a user index record for the user543 (not a member of group5) as follows:
% user543%:
firewall entries {
   tcp host.example.com http
}

In this non-limiting example, the user index record includes one destination from the modified ruleset for the user543 who is not part of the fifth group 350. Let it be assumed that a user879 in the organization structure 300 is part of the fifth group 350. In this non-limiting example, the firewall server 210 may be configured to generate a user index record for the user879 (member of the fifth group 350) as follows:
% user879% (member of group5):
lookup % metauser_group5%
firewall entries {
   udp corpdns.example.com 53
}

In this non-limiting example, the user index record for the user879 includes one destination from the last access rule from the modified ruleset, and references the meta-user index record of the meta-user representing the fifth group 350. As such, instead of storing three destinations in the user index record of the user879, the firewall server 210 stores one destination, and the two others can be looked up from the meta-user index record. It should be noted that so-storing destinations in user index records and meta-user index records may allow optimization storage resources for storing information indicative of access rules.

Developers of the present technology have realized that, although generating a meta-user index record for a given group and configuring look-up operations in user index records of users that are part of the given group may reduce storage resource requirements for storing information in a given ruleset, look-up operations require computational resources for execution. As a result, in a large-scale environment it is desirable to limit a total number of configured look-up operations in the user index records, even though they aid in reducing storage resource requirements.

In at least some embodiments of the present technology, the firewall server 210 may be configured to perform an optimization routine on one or more meta-user index records and one or more user index records generated based on the modified ruleset. During the optimization routine, the firewall server 210 may be configured to parse through the one or more user index records and identify at least one user index records in which a total number of configured look-up operations is above a pre-determined limit. The firewall server 210 may then be configured to update the at least one user index records by replacing at least one configured look-up operation by references to respective destinations in the meta-user associated with the at least one configured look-up operation.

In an other non-limiting example, let it be assumed that the firewall server 210 generates an other given modified ruleset. In this other non-limiting example, let it be assumed that based on the other given modified ruleset, the firewall server 210 generates a user index record for a user111 as follows:
% user111%:
lookup % metauser_group222%
lookup % metauser_group442342%
lookup % metauser_group4422%
firewall entries {
   udp ntp.example.com 123
}

Also, let it be assumed that the firewall server 210 has generated a meta-user index record for a group4422. It should be noted that the firewall server 210 may be configured to generate the meta-user index record for the group4422 similarly to what has been described above. Let it be assumed that the firewall server 210 is configured to generate the meta-user index record for the group4422 as follows:
% metauser_group4422%:
firewall entries {
   tcp tracker.example.com https
   tcp jabber.example.com 5222
}

In this non-limiting example, the user index record for the user111 is configured with four look-up operations, namely a first look-up operation for the meta-user index record associated with group222, a second look-up operation for the meta-user index record associated with group442342, a third look-up operation for the meta-user index record associated with group4422, and a fourth look-up operation for a table with destinations for the user111. Let it be assumed that the pre-determined limit is three look-up operations. In this non-limiting example, the firewall server 210 may be configured to update the user index record for the user111 as follows:
% user111%:
lookup % metauser_group222%
lookup % metauser_group442342%
firewall entries {
   udp ntp.example.com 123
   tcp tracker.example.com https
   tcp jabber.example.com 5222
}

In this non-limiting example, the firewall server 210 removed the third look-up operation for the meta-user index record associated with the group4422, and added the two destinations from the meta-user index record to the table with destinations for the user111. In this example, it is assumed that the meta-user index record for the group4422 includes the two destinations. It is contemplated that the meta-user index record for the group4422 may be generated similarly to what has been described above. As such, the updated user index record for the user111 now has a total of three look-up operations. It should be noted that in this non-limiting example, the meta-user index record associated with the group4422 may remain unchanged, and only the third look-up operation in the user index record for the user111 may in a sense be “unpacked” into the destination table of the user111 to reduce the computational load associated with the total number of look-up operations to be performed for the user111.

In at least some embodiments of the present technology, the firewall server 210 may be configured to select which of the one or more look-up operations are to be unpacked into the destination table of a given user index record. For example, the firewall server 210 may be configured to unpack one or more look-up operations with a lowest destination counts in the corresponding meta-user index records. As a result, the firewall server 210 may be configured to prioritize unpacking of look-up operations that are associated with a lowest number of destinations—so as to add a smallest number of destinations to the destination table of a given user index record in response to the unpacking procedure.

In an further embodiment of the present technology, the processor 110 may be configured to perform an optimization procedure onto one or more modified rules from a given modified ruleset.

In one example, let it be that the processor 110 is configured to generate a given modified access rule:
allow tcp from {% user6% or % user8% or % user9% or % user10% or % user12% or % user21% or % user22% or % user23% or % user24% or % user25% or % user30%} to host.another.example.com http

It this non-limiting example, the modified ruleset does not include any reference to a meta-user, and exclusively to individual users. It is contemplated that there may two reasons for such rules: a) explicit users are provided in the original rule or b) the original rule is provided using some group(s) that were not selected to be converted into a meta-user and thus, as a result of ruleset transformation, each and every user that is a member of that group(s) will be added into the rule via a direct user reference. For the sake of simplicity, we omit expanding group(s) not-selected-as-meta-user into an explicit user list. In some embodiments, the processor 110 may be configured to compare a number of user references in a given modified rule set to an additional pre-determined threshold value. In response to the number of user references in a given modified rule set being above the additional pre-determined threshold value, the processor 100 may be configured to perform the optimization procedure onto the given modified ruleset. The optimization procedure can be applied on one or more rulesets, without departing from the scope of the present technology.

In further embodiments, it can be said that if a number of individual users for whom a given rule will be added to their corresponding user index record exceeds a pre-determined threshold, the firewall 210 may be configured to modify the rule such that all groups are expanded to individual users (and/or meta-users if the group has been transformed into a meta-user). As such, during the optimization procedure, the firewall 210 may be configured to replace all groups in the given rule with the corresponding meta-users and/or explicit listings of users included in those groups.

In other embodiments, the processor 110 may be configured to compare a number of individual user references in a given modified rule set to an additional pre-determined threshold value. In response to the number of individual user references in a given modified rule set being above the additional pre-determined threshold value, the processor 100 may be configured to perform the optimization procedure onto the given modified ruleset.

In this non-limiting example, the processor 110 may be configured to determine that the given modified rule set has “11” references to individual users. Let it be assumed the additional pre-determined threshold value is equal to “3”. In this non-limiting example, the processor 110 may be configured to perform the optimization procedure onto the given modified ruleset. As it will be described in greater details herein further below, the processor 110 may be configured to generate an optimized modified rule for the given modified ruleset, by replacing some references to users from the modified ruleset to meta-users.

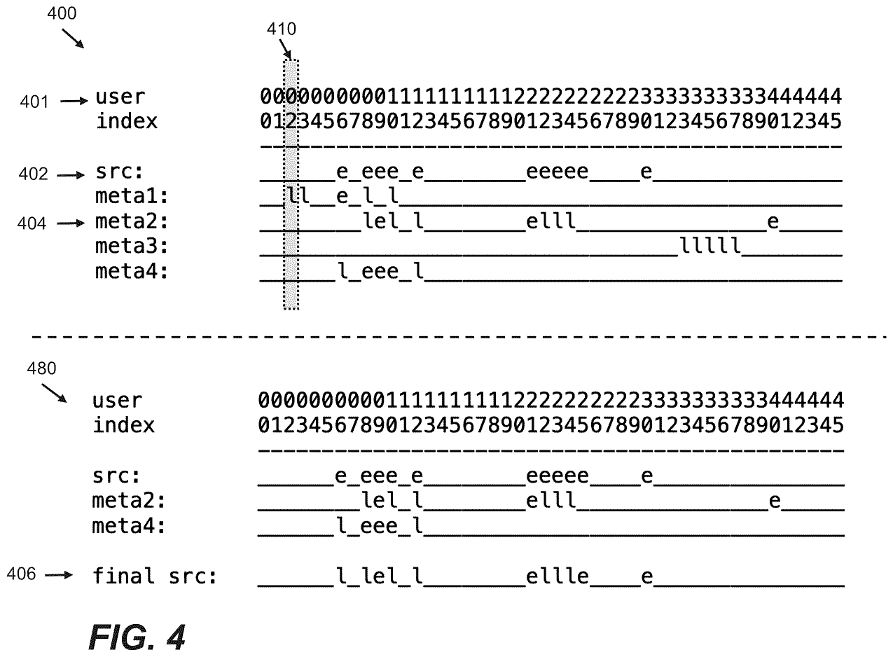

With reference to FIG. 4, there is depicted a first representation 400 of a processing pipeline executable by the processor 110 during the optimization procedure, and a second representation 480 of a processing pipeline executable by the processor 110 during the optimization procedure. As seen, a user index 401 represents respective user IDs in the database system (e.g., the index structure 240). An src index 402 represents references to particular userIDs from the user index. For example, an “e” indicator in the src index 402 is indicative of a given user ID having an expanded status in the modified ruleset, and where the expanded status is indicative of that the rule will be added to the user's corresponding user index record. It is contemplated other indicators may be included in the src index 402 in other implementations of the present technology. As such, the src index 402 for the given modified ruleset includes e indicators for the following userIDs:
% user6% ; % user8% ; % user9% ; % user10% ; % user12% ; % user21% ; % user22% ; % user23% ; % user24% ; % user25% ; % user30%

As seen, meta-user indexes 404 represent meta-user index records of meta-users in the database system (e.g., the index structure 240). In this non-limiting examples, the meta-user indexes 404 are illustrated for the following meta-users:
% meta1% ; % meta2% ; % meta3% ; % meta4%

For example, an “e” relation indicator in the meta-user indexes 404 is indicative of two conditions having been met for the user under the specified index—that is, (i) the user belongs to a group that has been transformed into the corresponding meta-user, and (ii) the user's ruleset explicitly contains all the rules involving the meta-user (i.e., all rules containing the meta-user are inserted into the user's table). In the same example, an “l” relation indicator in the meta-user indexes 404 is indicative of two conditions having been met for the user under the specified index—that is, (i) the user belongs to a group that has been transformed into the corresponding meta-user, and (ii) the user's ruleset references the meta-user in its own ruleset (i.e., the rules involving the meta-user are not inserted into the user's table and the user's ruleset contains a corresponding “lookup % meta-user %” instruction).

In this first representation 400, the processor 110 may be configured to determine which of the meta-users are to be selected for addition to the given modified rule set.

In a first example, the processor 110 may be configured to determine that the meta-user “meta1” may not be selected for addition to the given modified rule because of the user “user02” (see column 410, for example) and user “user03” are linked into meta-user “meta1”. It should be noted that if the meta-user “meta1” is added to the given modified ruleset, it will result in a non-authorized permission for the “user 02” and users “user 03” to the destination in the given modified ruleset.

In a second example, the processor 110 may be configured to determine that the meta-user “meta2” may be selected for addition to the given modified rule because inter alia all users that are linked in the meta-user index 404 of the meta-user “meta2” are expanded in the src index 402. It should be noted that the user “user09” and the user “user21” is expanded both in the meta-user index 404 of the meta-user “meta2” are in the src index 402. It should be noted that the user “user40” is expanded in the meta-user index 404 of the meta-user “meta2” but is not expanded in the src index 402. It should be noted that the user “user40” is not linking meta-user “meta2” and thus adding the meta-user “meta2” to the given modified ruleset will not create non-authorized permission(s) to the destination in the given modified ruleset.

In a third example, the processor 110 may be configured to determine that the meta-user “meta3” may not be selected for addition to the given modified rule because of the user “user 33”, the user “user 34”, the user “user 35”, the user “user 36”, and the user “user 37” are linked to meta-user “meta3”. It should be noted that if the meta-user “meta3” is added to the given modified ruleset, it will result in non-authorized permissions for the user “user33”, the user “user 34”, the user “user 35”, the user “user 36”, and the user “user 37” to the destination in the given modified ruleset.

In a fourth example, the processor 110 may be configured to determine that the meta-user “meta4” may be selected for addition to the given modified rule because inter alia users that are linked to the meta-user “meta4” are expanded in the src index 402, and users that are expanded in the meta-user “meta4” are also expanded in the src index 402. It should be noted that adding the meta-user “meta4” to the given modified ruleset will not create non-authorized permission(s) to the destination in the given modified ruleset.

As seen in the second representation 480, the meta-user indexes for the meta-users “meta1” and “meta3” are removed from further considerations while processing this particular rule. The processor 110 may be configured to generate a final src index 406 using the second representation 480. The final src index 406 is indicative of which userIDs are to be linked and/or to be expanded in the optimized modified ruleset. It should be noted that the final src index 406 is indicative of a following src in the optimized modified ruleset:
% user6% or % user8% or % user9% or % user10% or % user12% or % user21% or % user22% or % user23% or % user24% or % user25% or % user30% or % meta2% or % meta4%

In this non-limiting example, subsets of users are removed from the modified ruleset, as they are be referenced by meta-users with relation indicator ‘l’. In this non-limiting example, the processor 110 is configured to:
remove % user8%, % user10%, % user12%, % user22%, % user23%, % user24% as they have a link to % meta2% now added in the optimized modified ruleset
remove % user6% as he has a link to % meta4% now added in the optimized modified ruleset (% user12% has been removed already)

In this non-limiting example, the processor 110 is configured to generate the following final src for the optimized modifed ruleset:
% user9% or % user21% or % user25% or % user30% or % meta2% or % meta4%

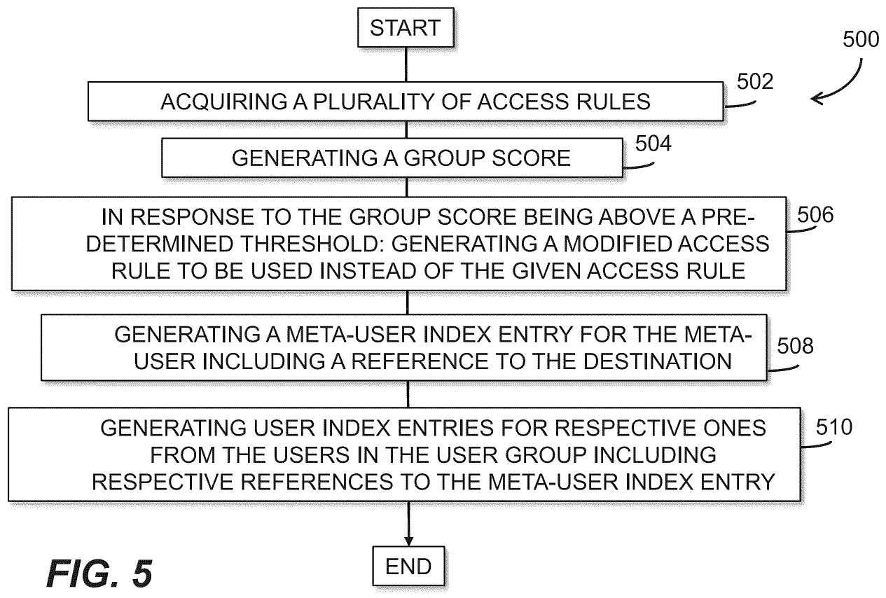

With reference to FIG. 5, there is depicted a scheme-block representation of a method 500 executable by the firewall server 210 illustrated in FIG. 2 and/or the processor 110 illustrated in FIG. 1. Various steps of the method 500 will now be discussed in greater detail.

### Step 502: Acquiring a Plurality of Access Rules

The method 500 continues to step 502, with the processor 110 and/or the firewall server 210 configured to acquire a plurality of access rules.

In some embodiments, the processor 110 and/or the firewall server 210 may be configured to acquire an original ruleset including one or more access rules. In other embodiments, the processor 110 and/or the firewall server 210 may be configured to generate a preliminary modified ruleset using one or more access rules.

It is contemplated that the processor 110 and/or the firewall server 210 may be configured to define one or more user entities for the system 250. It is contemplated that the processor 110 and/or the firewall server 210 may be configured to define one or more user groups including respective users from the one or more user entities for the system 250. The groups can be generated based on an organization grouping associated with the system 250 and/or may depending on inter alia various implementations of the present technology.

### Step 504: Generating a Group Score for a User Group

The method 500 continues to step 504 with the processor 110 and/or the firewall server 210 configured to generate a group score for a user group. In some embodiments, the processor 110 and/or the firewall server 210 may be configured to generate a group score for more than one groups referenced in at least one of an original access rule and a preliminary modified access rule. It is contemplated that the group score may be a product of destination count and a member count for the given group, however, other function for computing the group score are also contemplated.

### Step 506: In Response to the Group Score Being Above a Pre-Determined Threshold: Generating a Modified Access Rule Indicative of a Meta-User and the Destination

The method 500 continues to step 506 with the processor 110 and/or the firewall server 210 configured to, in response to the group score being above a pre-determined threshold, generate a modified access rule indicative of a meta-user and at least one destination. It is contemplated that the processor 110 and/or the firewall server 210 may be configured to generate a modified ruleset using one or more original access rules and/or one or more preliminary modified access rules.

It at least some embodiments, the at least one destination in the system 250 may be at least one of an IP address, a hostname, a subnetwork, a port, and a protocol within a resource of the system

### Step 508: Generating a Meta-User Index Record for the Meta-User

The method 500 continues to step 508 with the processor 110 and/or the firewall server 210 configured to generate a meta-user index record for a meta-user. In the non-limiting example described above, the processor 110 and/orthe firewall server 210 may be configured to generate a meta-user index record for the meta-user representing the fifth group 350 as follows:
% metauser_group5%:
firewall entries {
   tcp host.example.com http
   tcp secure.example.com http
}

It is contemplated that the processor 110 and/or the firewall server 210 may be configured to generate a respective meta-user index record for each group from the modified ruleset that is to be “transformed” into a meta-user entity.

### Step 510: Generating User Index Records for Respective Ones from the Users in the User Group

The method 500 continues to step 508 with the processor 110 and/or the firewall server 210 configured to generate user index records for respective ones from the users in the user group.

In the non-limiting example described above, the user879 in the organization structure 300 is part of the fifth group 350. In this non-limiting example, the processor 110 and/or the firewall server 210 may be configured to generate a user index record for the user879 (member of the fifth group 350) as follows:
% user879% (member of group5):
lookup % metauser_group5%
lookup firewall entries{
   udp corpdns.example.com 53
   . . .
   . . .
}

It is contemplated that the processor 110 and/or the firewall server 210 may be configured to generate a respective user index record for each user in a given group “transformed” in to a given meta-user entity.

It should be apparent to those skilled in the art that at least some embodiments of the present technology aim to expand a range of technical solutions for addressing a particular technical problem encountered by the conventional digital content item recommendation systems, namely selecting and providing for display digital content items that are relevant to the users.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implemented method for managing access to destinations in a system, the method executable by a processor, the method comprising:
acquiring a plurality of access rules,
a given access rule from the plurality of access rules being indicative of a user group and a destination, the given access rule for providing users in the user group with access to the destination;
generating a group score for the user group based on a number of users in the user group and a number of destinations for the user group amongst the plurality of access rules;
in response to the group score being above a pre-determined threshold:
generating a modified access rule indicative of a meta-user and the destination, the modified access rule to be used instead of the given access rule for providing the users in the user group with access to the destination;
generating a meta-user index record for the meta-user, the meta-user index record including information indicative of the destination; and
generating user index records for respective ones from the users in the user group, a given user index record including information indicative of the meta-user index record.

2. The method of claim 1, wherein a given user index record includes information indicative of a plurality of meta-user index records, the plurality of meta-user index records including the meta-user index record, the method further comprising:
in response to a number of meta-user index records in the plurality of meta-user index records being above an other pre-determined threshold:
updating the given user index record by replacing information indicative of the meta-user index record by information indicative of the destination.

3. The method of claim 1, wherein the method further comprises:
determining that a given modified access rule comprises references to a number of users that is above an other pre-determined threshold;
determining references to a set of users in the modified ruleset to be replaced by a reference to a first meta-user;
generating an optimized modified access rule to be used instead of the given modified access rule, the optimized modified access rule comprising the reference to the first meta-user instead of the references to a set of users in the given modified access rule.

4. The method of claim 1, wherein the destination is at least one of an IP address, a hostname, a subnetwork, a port, and a protocol within a resource of the system.

5. The method of claim 1, wherein the processor is a processor of a firewall server of the system.

6. The method of claim 1, wherein the method further comprises:
generating an index structure in a database system, the index structure including the meta-user index record and the user index record.

7. The method of claim 1, wherein the group score is a product of destination count and a member count for the given group.

8. A firewall server configured to:
acquire a plurality of access rules,
a given access rule from the plurality of access rules being indicative of a user group and a destination, the given access rule for providing users in the user group with access to the destination;
generate a group score for the user group based on a number of users in the user group and a number of destinations for the user group amongst the plurality of access rules;
in response to the group score being above a pre-determined threshold:
generate a modified access rule indicative of a meta-user and the destination, the modified access rule to be used instead of the given access rule for providing the users in the user group with access to the destination;
generate a meta-user index record for the meta-user, the meta-user index record including information indicative of the destination; and
generate user index records for respective ones from the users in the user group, a given user index record including information indicative of the meta-user index record.

9. The firewall server of claim 8, wherein a given user index record includes information indicative of a plurality of meta-user index records, the plurality of meta-user index records including the meta-user index record, the method firewall server being further configured to:
in response to a number of meta-user index records in the plurality of meta-user index records being above an other pre-determined threshold:
updating the given user index record by replacing information indicative of the meta-user index record by information indicative of the destination.

10. The firewall server of claim 8, wherein the firewall server is further configured to:
determine that a given modified access rule comprises references to a number of users that is above an other pre-determined threshold;
determine references to a set of users in the modified ruleset to be replaced by a reference to a first meta-user;
generate an optimized modified access rule to be used instead of the given modified access rule, the optimized modified access rule comprising the reference to the first meta-user instead of the references to a set of users in the given modified access rule.

11. The firewall server of claim 8, wherein the destination is at least one of an IP address, a hostname, a subnetwork, a port, and a protocol within a resource of the system.

12. The firewall server of claim 8, wherein the firewall server is further configured to:
generate an index structure in a database system, the index structure including the meta-user index record and the user index record.

13. The firewall server of claim 8, wherein the group score is a product of destination count and a member count for the given group.

14. A processor configured to:
acquire a plurality of access rules,
a given access rule from the plurality of access rules being indicative of a user group and a destination, the given access rule for providing users in the user group with access to the destination;
generate a group score for the user group based on a number of users in the user group and a number of destinations for the user group amongst the plurality of access rules;
in response to the group score being above a pre-determined threshold:
generate a modified access rule indicative of a meta-user and the destination, the modified access rule to be used instead of the given access rule for providing the users in the user group with access to the destination;
generate a meta-user index record for the meta-user, the meta-user index record including information indicative of the destination; and
generate user index records for respective ones from the users in the user group, a given user index record including information indicative of the meta-user index record.

15. The processor of claim 14, wherein a given user index record includes information indicative of a plurality of meta-user index records, the plurality of meta-user index records including the meta-user index record, the processor being further configured to:
in response to a number of meta-user index records in the plurality of meta-user index records being above an other pre-determined threshold:
update the given user index record by replacing information indicative of the meta-user index record by information indicative of the destination.

16. The processor server of claim 14, wherein the processor is further configured to:
determine that a given modified access rule comprises references to a number of users that is above an other pre-determined threshold;
determine references to a set of users in the modified ruleset to be replaced by a reference to a first meta-user;
generate an optimized modified access rule to be used instead of the given modified access rule, the optimized modified access rule comprising the reference to the first meta-user instead of the references to a set of users in the given modified access rule.

17. The processor of claim 14, wherein the destination is at least one of an IP address, a hostname, a subnetwork, a port, and a protocol within a resource of the system.

18. The processor of claim 14, wherein the processor is further configured to:
generate an index structure in a database system, the index structure including the meta-user index record and the user index record.

19. The processor of claim 14, wherein the group score is a product of destination count and a member count for the given group.

20. The processor of claim 14, wherein the processor is a processor of a firewall server communicatively coupled to a database system.
